(19) United States
(12) Patent Application Publication
(10) Pub. No.: US 2018/0224687 A1
(43) Pub. Date: Aug. 9, 2018

(54) PIXEL STRUCTURE, DISPLAY DEVICE AND DISPLAY PANEL HAVING THE DISPLAY DEVICE

(71) Applicants: BOE Technology Group Co., Ltd., Beijing (CN); Hefei BOE Optoelectronics Technology Co., Ltd., Anhui (CN)

(72) Inventor: Yuanhui Guo, Beijing (CN)

(73) Assignees: BOE Technology Group Co., Ltd., Beijing (CN); Hefei BOE Opotelectronics Technology Co., Ltd., Anhui (CN)

(21) Appl. No.: 15/570,938

(22) PCT Filed: May 10, 2017
(86) PCT No.: PCT/CN2017/083773

§ 371 Date: Oct. 31, 2017

(30) Foreign Application Priority Data
Jun. 17, 2016 (CN) 201610430316.3

(51) Int. Cl. G02F 1/1343; G02F 1/1333; G02F 1/1335

(52) U.S. Cl. CPC G02F 1/13439; G02F 1/133345; G09G 2300/0439; G02F 2201/123; G02F 2001/134372; G02F 1/133514

(57) ABSTRACT

The present disclosure relates to a pixel structure. The pixel structure comprises a first insulating layer, a common electrode layer formed by a common electrode, a second insulating layer and a pixel electrode layer formed by a plurality of pixel electrodes. The first electrode layer is disposed on the first insulating layer, the second insulating layer is disposed on the first electrode layer; a plurality of second electrodes are disposed on the second insulating layer at intervals. At least one of the first electrode layer and the second electrode layer is provided with a protrusion, or a recess, or a combination thereof. The present disclosure further relates to an array substrate, a display device, a display panel and a method for manufacturing the array substrate of the display device. In the present disclosure, liquid crystal molecules at positions of the electrodes and at positions between adjacent pixel electrodes are more likely to rotate from a vertical state to a tilting state, to cause the speeds of the liquid crystal molecules at the two positions changing between a bright state and a dark state tend to be the same. Thus, the flicker phenomenon does not occur easily.

### CROSS-REFERENCE TO RELATED APPLICATION

This application claims priority to Chinese Patent Application No. 201610430316.3 filed with the State Intellectual Property Office on Jun. 17, 2016, which is incorporated herein by reference in its entirety as a part of the present application.

### TECHNICAL FIELD

The present disclosure relates to the field of displays, and more particularly to a pixel structure, a display device and a display panel having the display device.

### BACKGROUND

In the technical field of displays, a thin film transistor liquid crystal display (TFT-LCD) is a main liquid crystal display device.

In accordance with different directions of electric fields driving the crystal liquid, the TFT-LCDs can be divided into vertical electric field type TFT-LCDs and horizontal electric field TFT-LCDs. For a vertical electric field TFT-LCD, pixel electrodes are formed on an array substrate and a common electrode is formed on a color filter substrate. For a horizontal electric field TFT-LCD, the pixel electrodes and the common electrode are formed on the array substrate simultaneously. The horizontal electric field TFT-LCD comprises an in-plane switching (IPS) mode and a fringe field switching (FFS) mode.

Compared with the IPS display mode, the FFS display mode has been widely applied to the field of high-end displays due to a high transmittance and an enlarged viewing angle.

### SUMMARY

Embodiments of the present disclosure provide a pixel structure, an array substrate having the pixel structure, a display device, a display panel, and a method for manufacturing an array substrate of the display device.

According to a first aspect of the present disclosure, there is provided a pixel structure. The pixel structure comprises a first insulating layer, a first electrode layer formed by a first electrode, a second insulating layer and a second electrode layer formed by a plurality of second electrodes. The first electrode layer is disposed on the first insulating layer, the second insulating layer is disposed on the first electrode layer; the plurality of second electrodes are disposed on the second insulating layer at intervals. At least one of the first electrode layer and the second electrode layer has a protrusion, or a recess, or a combination thereof.

In the embodiments of the present disclosure, each second electrode has a protrusion or a recess.

In the embodiments of the present disclosure, the first electrode has a protrusion or a recess at a position corresponding to the position between two adjacent second electrodes.

In the embodiments of the present disclosure, the first electrode has a protrusion or a recess at a position corresponding to the second electrode.

In some embodiments of the present disclosure, the surface of the second insulating layer is provided with a protrusion, or a recess, or a combination thereof, and the second electrode conformally covers the second insulating layer, to cause the plurality of second electrodes to have a protrusion or a recess.

In the embodiments of the present disclosure, the surface of the first insulating layer is provided with a protrusion or a recess at a position corresponding to the position between two adjacent second electrodes, and the first electrode conformally covers the first insulating layer, to cause the first electrode to have a protrusion or a recess at the position corresponding to the position between two adjacent second electrodes.

In the embodiments of the present disclosure, the surface of the first insulating layer is further provided with a protrusion or a recess at the position corresponding to the second electrode, to cause the first electrode to further have a protrusion or a recess at the position corresponding to the second electrode.

In the embodiments of the present disclosure, the second insulating layer conformally covers the first electrode, to cause the second insulating layer to have a protrusion or a recess at the position corresponding to the second electrode and at the position corresponding to the position between two adjacent second electrodes; and the second electrodes conformally cover the second insulating layer, to cause the plurality of second electrodes to have a protrusion or a recess.

In the embodiments of the present disclosure, the protrusion or the recess has the same shape.

In the embodiments of the present disclosure, the shape of the protrusion or the recess is selected from a triangle, a trapezoid, a convex polygon, an arc, or a combination thereof.

In the embodiments of the present disclosure, the protrusion or the recess is shaped like an isosceles triangle and a base angle of the isosceles triangle is 30°.

In the embodiments of the present disclosure, the first insulating layer comprises an organic material; and the second insulating layer comprises silicon nitride or silicon oxide.

According to another aspect of the present disclosure, there is provided an array substrate. The array substrate comprises the pixel structure described above.

According to another aspect of the present disclosure, there is provided a display device. The display device comprises a color filter substrate, an array substrate arranged opposite to the color filter substrate and a liquid crystal molecular layer filled between the color filter substrate and the array substrate; and the array substrate is provided with the pixel structure described above.

According to another aspect of the present disclosure, there is provided a display panel. The display panel comprises the display device described above.

According to another aspect of the present disclosure, there is provided a method for manufacturing an array substrate of a display device. The method comprises the following steps: forming a first insulating layer on a substrate; forming a first electrode layer comprising a first electrode on the first insulating layer; forming a second insulating layer on the first electrode layer; and forming a plurality of second electrodes on the second insulating layer at intervals to form a second electrode layer. At least one of the first electrode layer and the second electrode layer has a protrusion, or a recess, or a combination thereof.

In the embodiments of the present disclosure, at least one of the first insulating layer and the second insulating layer is formed to have a protrusion, or a recess, or a combination thereof, and the first electrode layer and the second electrode layer are conformally formed on the first insulating layer and the second insulating layer, respectively, to cause at least one of the first electrode layer and the second electrode layer to have a protrusion or a recess, or a combination thereof.

In the embodiments of the present disclosure, the first insulating layer is formed to have a protrusion, or a recess, or a combination thereof, and the first electrode layer, the second insulating layer and the second electrode layer are conformally formed on the first insulating layer in sequence, to cause the first electrode layer to have a protrusion or a recess at the position corresponding to the second electrode and at the position corresponding to the position between two adjacent second electrodes, and each second electrode to have a protrusion or a recess.

In the embodiments of the present disclosure, a protrusion, or a recess, or a combination thereof is formed on the first insulating layer by a halftone mask patterning process.

In the embodiments of the present disclosure, a protrusion, or a recess, or a combination thereof is formed on the first insulating layer by an imprinting process.

In the embodiments of the present disclosure, a protrusion, or a recess, or a combination thereof is formed on the first insulating layer by a printing process.

A pixel structure, an array substrate comprising the pixel structure, a display device comprising the array substrate, a display panel comprising the display device, and a method for manufacturing the above array substrate are provided in the present disclosure. A plurality of protrusions are disposed on at least one of the surface of the first insulating layer facing the common electrode, the surface of the second insulating layer facing the pixel electrodes, the common electrode layer and the pixel electrode layer, to enable at least the liquid crystal molecules at the positions of the pixel electrodes to rotate from a vertical state to a tilting state more easily, and to enable the rotary directivity of the liquid crystal molecules to be clearer. Thus, the speeds of the liquid crystal molecules rotating between a bright state and a dark state tend to be the same, and therefore a flicker phenomenon does not easily occur.

### BRIEF DESCRIPTION OF THE DRAWINGS

When read with reference to the accompanying drawings, a comprehensive understanding to the present disclosure can be completely understood from description to the following preferable embodiments. In the drawings:

FIG. 1 shows a schematic diagram of a liquid crystal arrangement and an electric field distribution of a horizontal electric field type display device in a FFS mode when a voltage of pixel electrodes is a positive voltage in the related art;

FIG. 2 shows a schematic diagram of a liquid crystal arrangement and an electric field distribution of a horizontal electric field type display device in a FFS mode when a voltage of pixel electrodes is a negative voltage in the related art;

FIG. 3 shows a schematic diagram of an electric field distribution of a horizontal electric field type display device in a FFS mode when a voltage of pixel electrodes is a positive voltage in the related art;

FIG. 4 shows a schematic diagram of an electric field distribution of a horizontal electric field type display device in a FFS mode when a voltage of pixel electrodes is a negative voltage in the related art;

FIG. 5 shows a schematic diagram of liquid crystal molecules rotating along with an electric field direction in a near-vertical state;

FIG. 6 shows a schematic diagram of liquid crystal molecules rotating along with an electric field direction in a tilting state;

FIG. 7 shows a brightness curve of a display device at different times in a FFS mode;

FIG. 8 shows a sectional schematic diagram of an exemplary display device in accordance with an embodiment of the present disclosure;

FIG. 9 shows a sectional schematic diagram of an exemplary display device in accordance with another embodiment of the present disclosure;

FIG. 10 shows a sectional schematic diagram of an exemplary display device in accordance with a further embodiment of the present disclosure;

FIG. 11 shows a sectional schematic diagram of an exemplary display device in accordance with a further embodiment of the present disclosure;

FIG. 12 shows a schematic diagram of an electric field distribution when a voltage of pixel electrodes of the display device in accordance with the embodiment shown in FIG. 11 is a positive voltage;

FIG. 13 shows a schematic diagram of an electric field distribution when a voltage of pixel electrodes of the display device in accordance with the embodiment shown in FIG. 11 is a negative voltage;

FIG. 14 shows a sectional schematic diagram of a display device having a planar electrode in the related art;

FIG. 15 shows a sectional schematic diagram of a display device having bump electrodes in accordance with the present disclosure;

FIG. 16 shows brightness-time curves of a display device having planar electrodes in the related art and a display device having bump electrodes in the present disclosure;

FIG. 17 shows a sectional schematic diagram of a display device having recess pixel electrodes and a recess common electrode in accordance with an embodiment of the present disclosure;

FIG. 18 shows a sectional schematic diagram of an exemplary pixel structure in accordance with an embodiment of the present disclosure;

FIG. 19 shows a schematic diagram of a method for preparing a first insulating layer of an array substrate of a display device of the present disclosure; and

FIG. 20 shows a schematic diagram of another method for preparing a first insulating layer of an array substrate of a display device of the present disclosure.

### DETAILED DESCRIPTION

Hereinafter, the technique solutions in the embodiments of the present disclosure will be described in a clear and detailed manner with reference to the drawings of the present disclosure. It is to be understood that the specific embodiments of the present disclosure are exemplary only and are not restrictive of the protection scope of the present disclosure.

At first, it should be noted that in embodiments of the present disclosure, “conformally” means that a second layer and a first layer have the same or similar surface appearances, when the second layer is disposed on the first layer.

As mentioned above, compared with the IPS display mode, the FFS display mode has a high transmittance and an enlarged viewing angle. Specifically, in the FFS display mode, transparent indium tin oxide (ITO) is adopted as the electrodes of the TFT-LCD, to enable higher transmittance, and the positive and negative electrodes are separated by an insulating layer and then are superimposed to reduce electrode widths and intervals to enlarge the viewing angle. However, since the brightness of the pixel electrodes in the FFS display mode suddenly decays during switching between positive and negative frames, the brightness difference is large at different moments. Therefore, the TFT-LCD generates a flicker phenomenon more easily in the FFS display mode.

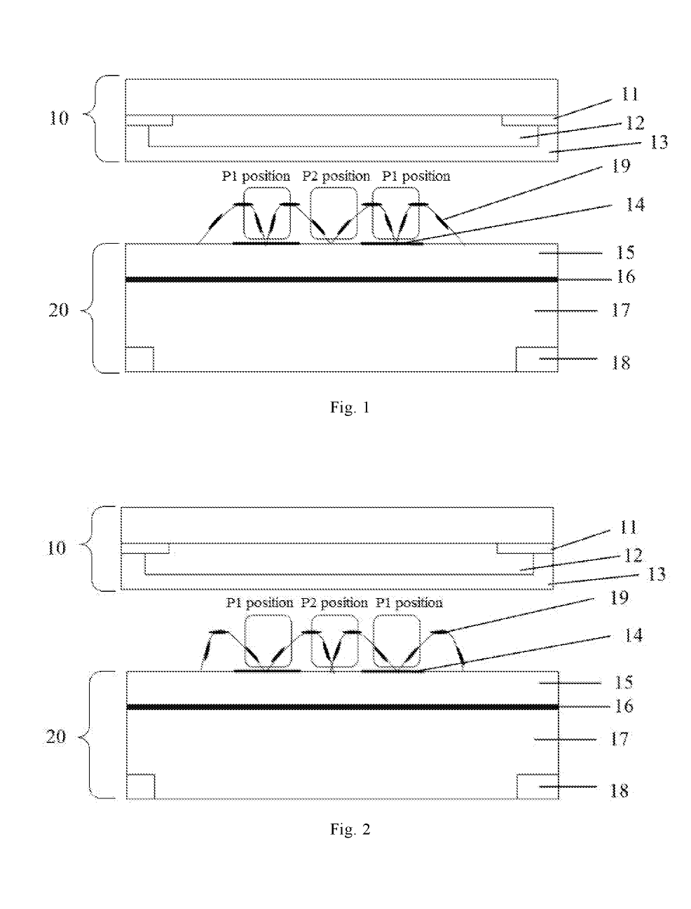

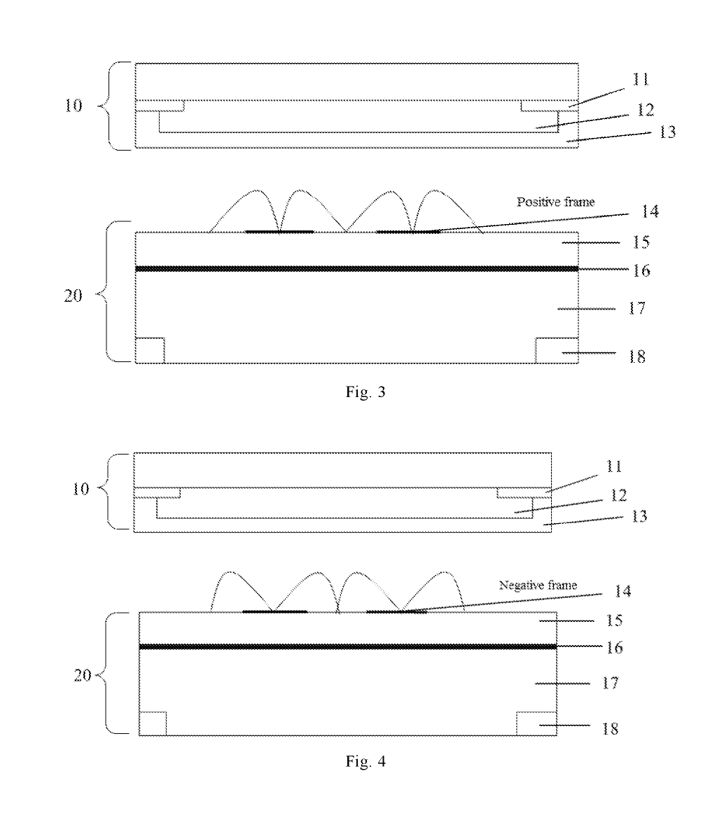

FIGS. 1 and 2 show schematic diagrams of a liquid crystal arrangement and an electric field distribution of a horizontal electric field type display device in a FFS mode when a voltage of pixel electrodes is a positive voltage and a negative voltage respectively in the related art. FIGS. 3 and 4 show schematic diagrams of an electric field distribution of a horizontal electric field type display device in a FFS mode when a voltage of pixel electrodes is a positive voltage and a negative voltage respectively in the related art. As shown in FIGS. 1 to 4, the display device comprises a color filter substrate 10, an array substrate 20 and a liquid crystal molecular layer disposed between the color filter substrate 10 and the array substrate 20. The array substrate 20 comprises a signal line 18, a first insulating layer 17, a common electrode layer consisting of a common electrode 16, a second insulating layer 15 and a pixel electrode layer consisting of a plurality of pixel electrodes 14. The color filter substrate 10 and the array substrate 20 are oppositely disposed (face to face) and both of them are disposed on one side of a backlight module (not shown). The color filter substrate 10 comprises a black matrix 11, a RGB color filter 12 and a planarization layer 13. The array substrate 20 generates an electric field capable of controlling liquid crystal molecules 19 through the pixel electrodes 14 and the common electrode 16 disposed thereon. Orientation of the liquid crystal molecules 19 that are distributed in the liquid crystal molecular layer changes along with the distribution of the electric field generated in the array substrate 20.

In the configurations as shown in FIGS. 1 to 4, an upper surface of the first insulating layer 17 (i.e., the surface facing the common electrode 16) is a flat surface. The planar common electrode 16 is disposed on the first insulating layer 17. The second insulating layer 15 is disposed on the common electrode 16 and an upper surface thereof (i.e., the surface away from the first insulating layer 17) is a flat surface. The planar pixel electrodes 14 are disposed on the second insulating layer 15 at intervals. In FIGS. 1 and 2, liquid crystal regions corresponding to the pixel electrodes 14 are P1 regions, while the region corresponding to the position between adjacent pixel electrodes 14 is a P2 region.

Referring to FIGS. 1 to 4, the electric field distribution and liquid crystal arrangement of the horizontal electric field type TFT-LCD display device in the FFS mode are analyzed when the voltage of the pixel electrodes is the positive voltage and the negative voltage (i.e., the positive frames and negative frames) respectively.

When no voltage is applied to the pixel electrodes 14, no electric field exists between the array substrate 20 and the color filter substrate 10. Here, the liquid crystal molecules in the liquid crystal molecular layer are distributed in an orientation parallel to the substrate. When the positive voltage is applied to the pixel electrodes 14, the liquid crystal molecules 19 are distributed along the electric field directions shown in FIGS. 1 and 3. Here, bright regions concentrate in the P1 regions and dark regions concentrate in the P2 region. When the negative voltage is applied to the pixel electrodes 14, the liquid crystal molecules 19 are distributed along the electric field directions shown in FIGS. 2 and 4. Here, the bright regions concentrate in the P2 region and the dark regions concentrate in the P1 regions. When the pixels are switched between the positive and negative frames, the bright regions and dark regions in the P1 positions and the P2 position are switched.

Theoretically, when a time-brightness changing situation of the pixel units from a bright state to a dark state in P1 regions is totally same as the time-brightness changing situation of the pixel units from the dark state to the bright state in P2 region, the brightness and the speeds of brightness change of the pixel units of the positive and negative frames are same. Therefore, the flicker phenomenon does not occur to the screen. However, in practice, the time-brightness changing situation of the liquid crystal molecules mutually switching between the bright state and the dark state is different during the switching between the positive and negative frames. As a result, the brightness of the pixel units varies greatly at different moments, and therefore the flicker phenomenon is generated.

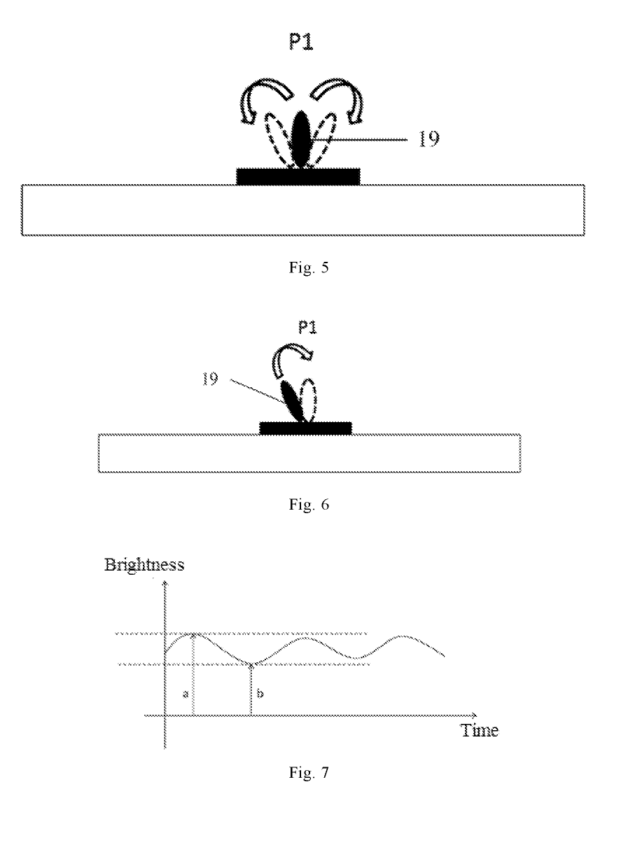

FIG. 5 shows a schematic diagram of the liquid crystal molecules 19 in P1 regions rotating along with an electric field direction in a near-vertical state. When in the positive frames, the liquid crystal molecules 19 approach to a totally vertical state and the pixels are in the bright state. When the positive frames are switched to the negative frames, the pixel electrodes 14 and the common electrode 16 of the array substrate 20 generate electric fields for changing the pixels from the bright state to the dark state. Since the electric fields on the left and right sides are basically same, forces applied to the liquid crystal molecules are basically equal in each tilting directions. Therefore, the rotary directivity of the liquid crystal molecules 19 from a vertical state to a tilting state is unclear. As a result, when gradually approaching to the totally vertical state, the liquid crystal molecules 19 are more unlikely to rotate to both sides, thereby slowing down the speed of the pixels changing from the bright state to the dark state.

Correspondingly, FIG. 6 shows a schematic diagram of the liquid crystal molecules 19 rotating along an electric field direction in a tilting state. When in the negative frames, the liquid crystal molecules 19 are in the tilting state, and the pixels are in the dark state. When the negative frames are switched to the positive frames, the pixel electrodes 14 and the common electrode 16 of the array substrate 20 generate electric fields for rotating the liquid crystal molecules from the tilting state to the vertical state. Since the directivity of the liquid crystal molecules 19 rotating from the tilting state to the vertical state is clearer than that of the liquid crystal molecules 19 rotating from the vertical state to the tilting state, the speed of the pixels changing from the dark state to the bright state is faster. The larger the tilting angle of the liquid crystal molecules is, the clearer the directivity of the liquid crystal molecules rotating along the electric field direction is. As a result, the speed of the pixels changing from the dark state to the bright state is faster.

The situation of the pixels changing between the bright state and the dark state at P2 position is similar to that of the pixels at P1 positions.

Therefore, when the solutions as shown in FIGS. 1 to 4 are in display of the positive and negative frames, vertical field components generated between the pixel electrodes 14 and the common electrode 16 are more, thereby causing the problem of unclear orientation of the liquid crystal molecules in a near-vertical state during the switching between the positive and negative frames.

Due to above speed difference of the pixels changing between the bright state and the dark state, when the pixels change from the dark state to the bright state at P1 positions, and change from the bright state to the dark state at P2 position, the changing speed at the P1 positions is faster, while the changing speed at P2 position is slower. Otherwise, when the pixels change from the bright state to the dark state at P1 positions, and change from the dark state to the bright state at P2 position, the similar changing speed difference also exists. Therefore, the P1 positions and P2 position cannot present the perfect brightness complementation. A phenomenon S of brightness decay occurs at a certain intermediate moment. As a result, the brightness difference of the display device is large at different moments, and therefore the flicker phenomenon is generated.

FIG. 7 shows a brightness curve of a display device at different times in the FFS mode. The brightness curve embodies the above phenomenon of brightness decay. It can be found that when a relative brightness difference at moments of a and b is large, the flicker phenomenon is more obvious.

Therefore, the planar electric field type TFT-LCD display device needs to be improved to overcome or weaken the flicker defect caused by the above brightness difference. One of the ways for eliminating the above defect is to adjust the changing speed of the liquid crystal molecules between switching from the vertical state to the tilting state and switching from the tilting state to vertical state in order to reduce the changing speed difference thereof as much as possible.

The embodiments of the present disclosure provide a display device. The display device comprises a first insulating layer, a first electrode layer consisting of a first electrode, a second insulating layer, and a second electrode layer consisting of a plurality of second electrodes. In the embodiments of the present disclosure, the first electrode layer is disposed on the first insulating layer. The second insulating layer is disposed on the first electrode layer. The plurality of second electrodes are disposed on the second insulating layer at intervals. At least one of the first electrode layer and the second electrode layer has a protrusion.

In the embodiments of the present disclosure, the first electrode may be a common electrode, and the second electrodes may be pixel electrodes. It should be understood that other embodiments may also be applicable. For example, the first electrode is the pixel electrode, and the second electrodes are the common electrodes. The exemplary embodiment of the present disclosure is described in details by taking an example in which the common electrode is the first electrode and the pixel electrodes are the second electrodes with reference to the drawings.

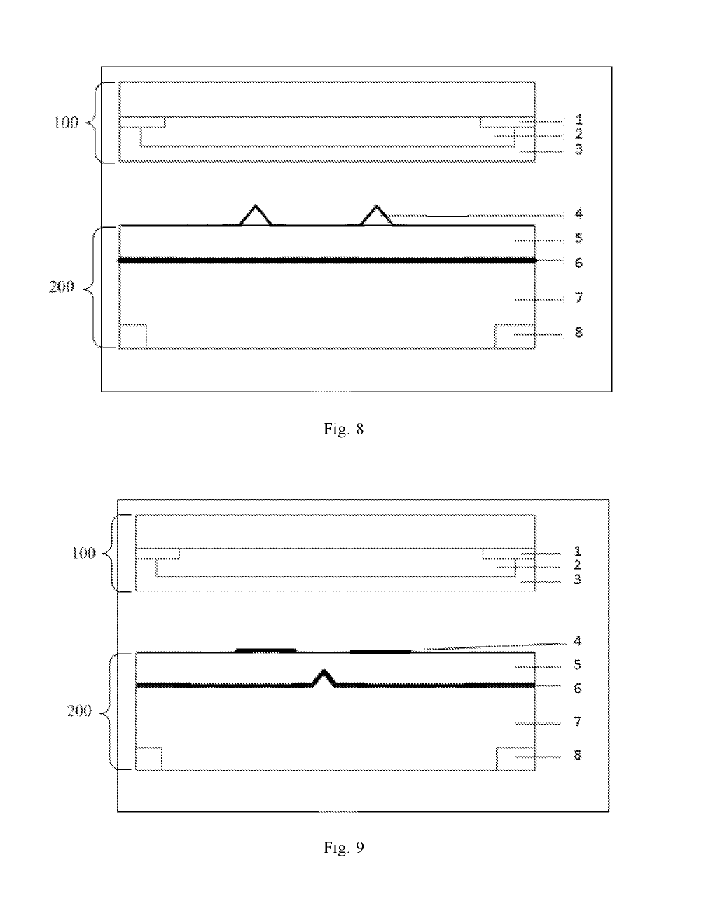

FIG. 8 shows a sectional schematic diagram of an exemplary display device in accordance with an embodiment of the present disclosure. As shown in FIG. 8, the display device provided in the embodiments of the present disclosure comprises a color filter substrate 100, an array substrate 200 and a liquid crystal molecular layer disposed between the two substrates. The array substrate 200 comprises a signal line 8, a first insulating layer 7, a common electrode layer consisting of a common electrode 6, a second insulating layer 5 and a pixel electrode layer consisting of a plurality of pixel electrodes 4. The color filter substrate 100 and the array substrate 200 are disposed oppositely. The color filter substrate 100 may comprise a black matrix 1, a RGB color filter 2 and a planarization layer 3.

In the embodiment shown in FIG. 8, each pixel electrode 4 has a protrusion. In the exemplary embodiment, positions of the second insulating layer 5 corresponding to the pixel electrodes 4 may be provided with the protrusions. Besides, the pixel electrodes 4 conformally cover the second insulating layer 5, to cause the pixel electrode 4 to have a protrusion.

In this configuration, the pixel electrode 4 is provided with protrusion, and therefore the electric field direction in the P1 region may be changed, thereby reducing vertical field components of the electric fields of the P1 region, and increasing horizontal field components thereof. In such electric fields, when the liquid crystal molecules in P1 region change to the tilting state from the vertical state or from the near-vertical state, forces applied to the liquid crystal molecules in different directions are different, causing the rotary orientation of the liquid crystal molecules to be clearer during the switching between the positive and negative frames. Thus, the liquid crystal molecules are more likely to change to the tilting state from the vertical state or from the near-vertical state. In this way, when the pixel electrodes 4 are switched from the positive voltage to the negative voltage, the speed of changing from the bright state to the dark state at P1 positions approaches to the speed of changing from the dark state to the bright state at P2 position. Therefore, the brightness changes at the P1 and P2 positions can better complement, thereby at least partially improving the flicker problem caused by different speeds of the brightness change at P1 positions and P2 position.

In the embodiment of the present disclosure, the first insulating layer 7 may be made of an organic material. The second insulating layer 5 may be made of silicon nitride or silicon oxide. The pixel electrodes 4 may be made of indium tin oxide (ITO).

FIG. 9 shows a sectional schematic diagram of an exemplary display device in accordance with another embodiment of the present disclosure. In the embodiment shown in FIG. 9, the common electrode 6 is provided with a protrusion at a position corresponding to the position between two adjacent pixel electrodes 4. In the exemplary embodiment, the protrusion may be disposed on the surface of the first insulating layer 7 corresponding to the position between the two adjacent pixel electrodes 4. The common electrode 6 conformally covers the surface of the first insulating layer 7, thereby causing the common electrode 6 to have a protrusion at the position corresponding to the position between the two adjacent pixel electrodes 4.

In this configuration, compared with the planar common electrode, the electric field at the position between two pixels (i.e., the P2 position) is changed, thereby causing the liquid crystal molecules in the P2 region to be more likely to change to the tilting state from the vertical state. In this way, when the pixel electrodes are switched from the negative voltage to the positive voltage, the speed of changing from the bright state to the dark state at P2 position approaches to the speed of changing from the dark state to the bright state. Therefore, the brightness changes at P1 positions and P2 position can better complement, thereby at least partially improving the flicker problem caused by different speeds of the brightness change at P1 positions and P2 position.

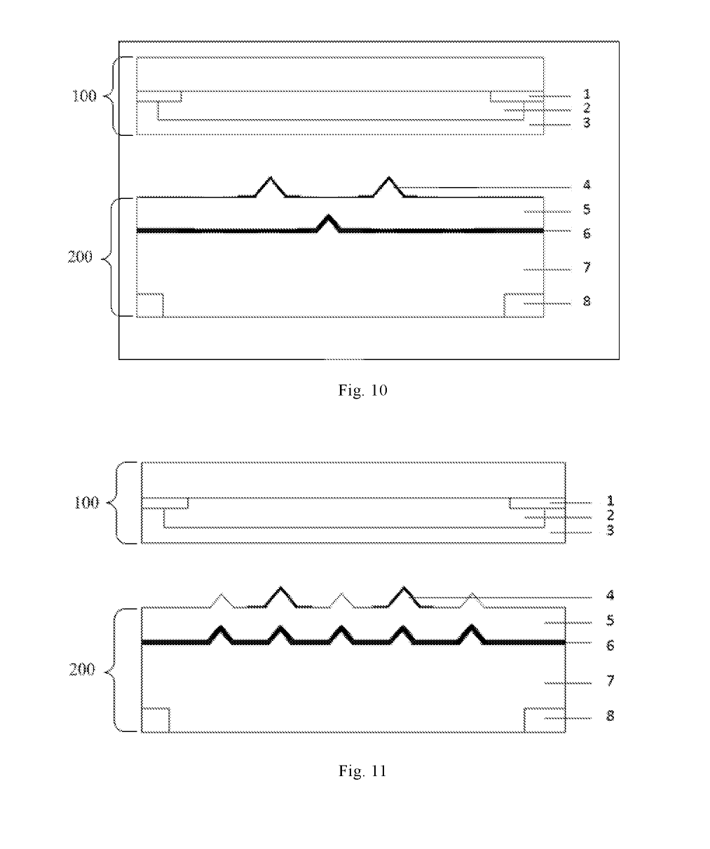

FIG. 10 shows a sectional schematic diagram of an exemplary display device in accordance with yet another embodiment of the present disclosure. In the embodiment as shown in FIG. 10, each pixel electrode 4 has a protrusion. The common electrode 6 has a protrusion at the position corresponding to the position between two adjacent pixel electrodes 4. In the exemplary embodiment, the protrusion may be disposed on the surface of the first insulating layer 7 corresponding to the position between the two adjacent pixel electrodes 4. The common electrode 6 conformally covers the surface of the first insulating layer 7, to cause the common electrode 6 to have the protrusion at the position corresponding to the position between the two adjacent pixel electrodes 4. Besides, the second insulating layer 5 has a protrusion at the position corresponding to the pixel electrode 4, and the pixel electrode 4 conformally covers the second insulating layer 5, to cause the each pixel electrode 4 to have a protrusion.

In the configuration shown in FIG. 10, no matter the positive frames are switched to the negative frames or the negative frames are switched to the positive frames, the brightness changes of the P1 positions and the P2 positions can better complement. Therefore, the flicker problem caused by different change speeds of the brightness at P1 positions and P2 position is improved.

FIG. 11 shows a sectional schematic diagram of an exemplary display device in accordance with a still further embodiment of the present disclosure. In the embodiment shown in FIG. 11, the upper surface of the first insulating layer 7 is provided with a protrusion. The common electrode 6 conformally covers the second insulating layer 7, to cause the common electrode 6 to have a protrusion, too. The second insulating layer 5 conformally covers one side of the common electrode 6 that is away from the first insulating layer 7, to cause the second insulating layer 5 to have a protrusion on the surface thereof. The plurality of pixel electrodes 4 are conformally disposed on the protrusion of the second insulating layer 5, to cause each pixel electrode 4 to have a protrusion. The common electrode 6 is provided with a protrusion at the position corresponding to the each pixel electrode 4 and at the position corresponding to the position between two adjacent pixel electrodes 4. In this embodiment, apart from the positions corresponding to the pixel electrodes 4, the common electrode 6 is further provided with protrusions at the positions corresponding to the positions between two adjacent pixel electrodes 4. Through this configuration, a plurality of protrusions may be formed in a process of forming the first insulating layer, and then the common electrode, the second insulating layer and the pixel electrodes are conformally formed on the first insulating layer in sequence, thereby simplifying the process and improving the production efficiency.

In the embodiments of the present disclosure, the at least one protrusion may be shaped like selected from, for example, a triangle, a trapezoid, a convex polygon, an arc, or a combination thereof. The present disclosure is illustrated by taking an example in which the protrusion is shaped like a triangle. It should be understood that the above example for the protrusion is exemplary only and is not restrictive of the present disclosure.

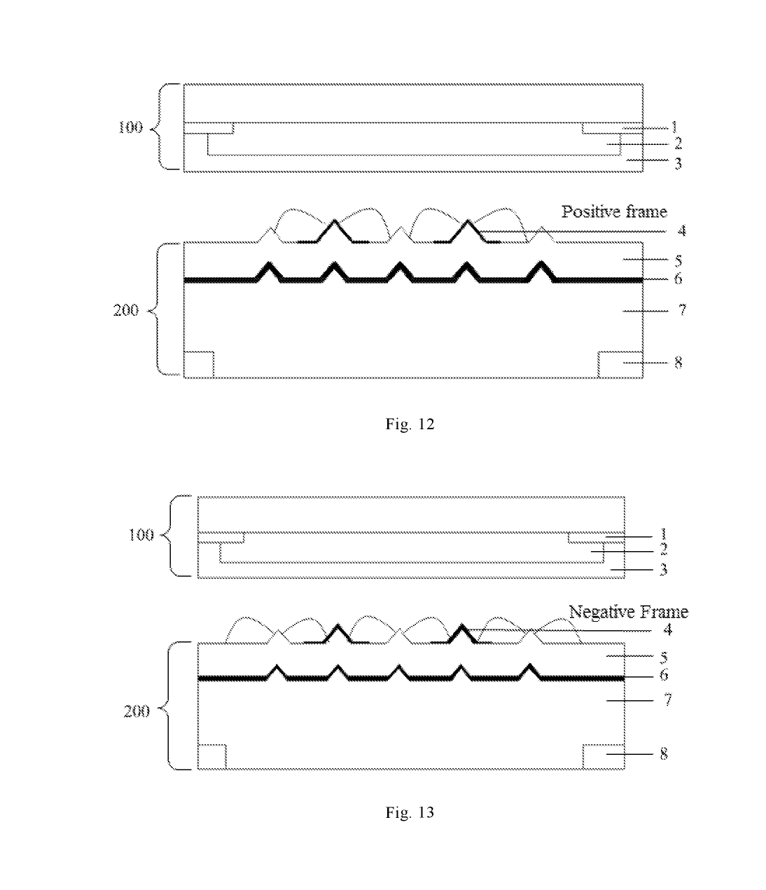

When the positive voltage and the negative voltage are applied to the pixel electrodes 4 of the array substrate of the display device as shown in FIG. 11, electric fields are generated between the pixel electrodes 4 and the common electrode 6, causing the liquid crystal molecules to distribute along the electric field direction. FIGS. 12 and 13 show schematic diagrams of electric field distributions when a voltage of the pixel electrodes of the display device as shown in FIG. 11 is the positive voltage and the negative voltage (i.e., the positive frame and negative frame display) respectively. By disposing the protrusion on the pixel electrodes 4 and on the common electrode 6, the vertical field components of the generated electric fields are less, and most of the electric field components are horizontal. In this electric field, the liquid crystal molecules in P1 and P2 regions are more unlikely to be in the vertical state but are more likely to be in the tilting state. In this way, since the forces applied to the liquid crystal molecules are different in different directions when the liquid crystal molecules change to the tilting state from the vertical state or from the near-vertical state under the action of the electric fields generated in P1 regions and P2 region, the rotary orientation of the liquid crystal molecules are clearer during the switching between the positive and negative frames, and the liquid crystal molecules are more likely to change to the tilting state from the vertical state or from the near-vertical state. Therefore, the changing speeds of the liquid crystal molecules at the P1 and P2 positions rotating to the tilting state from the vertical state and rotate to the vertical state from the tilting state tend to be the same. As a result, the brightness decay caused by the changing speed difference is more unlikely to occur, and therefore the flicker phenomenon can be avoided.

The technical effects of the structure of the display device of the present disclosure can be verified through experiments.

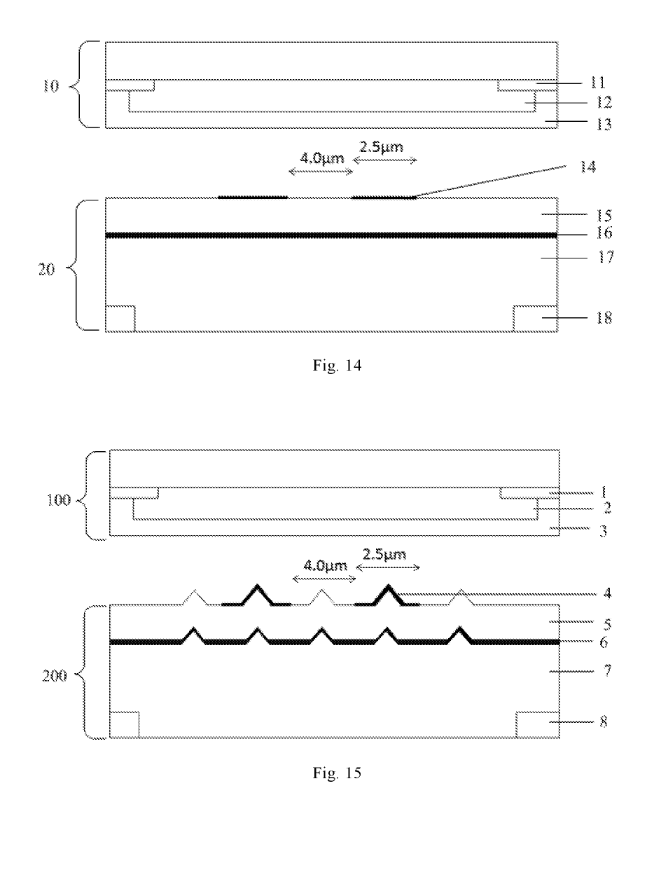

In FIG. 14, the array substrate of the display device in the related art adopts planar electrodes (comprising the pixel electrodes and the common electrode). A pixel size is 20 μm×60 μm. A horizontal width of the pixel electrode is 2.5 μm. A slit width between adjacent pixel electrodes is 4.0 μm. While the array substrate of the display device provided in the embodiment in FIG. 15 adopts bump electrodes (comprising the pixel electrodes and the common electrode). The pixel size and the horizontal width of the pixel electrodes are totally consistent with those in FIG. 14. A tape angle of the protrusion of the pixel electrode and the common electrode is 30°. In this embodiment, when a shape of the protrusion is an isosceles triangle, the tape angle of the protrusion is the base angle of the isosceles triangle. Specifically, for the protrusion of the pixel electrodes, the tape angle is an angle formed by the surface of the second insulating layer and the bevel edge of a section of the protrusion as shown in the drawing. Similarly, for the protrusion of the common electrode, the tape angle is an angle formed by the surface of the first insulating layer and the bevel edge of a section of the protrusion as shown in the drawing.

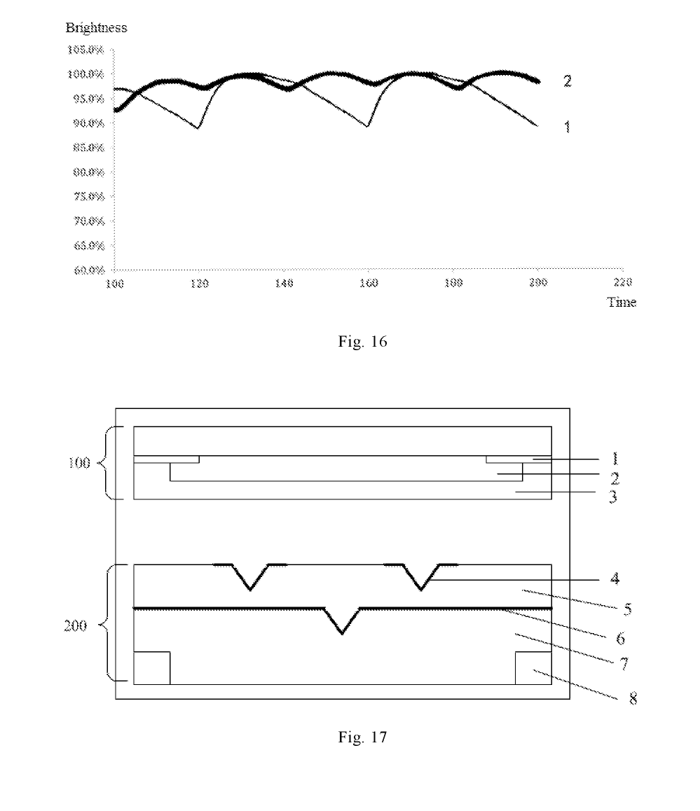

FIG. 16 shows brightness-time curves of a display device having the planar electrodes in the related art and the display device having bump electrodes in the present disclosure, and specifically, shows a comparison result between the brightness-time relation of the display device in the embodiment of the present disclosure shown in FIG. 15 and the brightness-time relation of the display device in the related art shown in FIG. 14, obtained by a simulation and analysis software called Techwiz V16. In FIG. 16, the thin solid line shows the brightness-time relation of the pixels adopting a flat pixel structure in the related art, and the thick solid line shows the brightness-time relation of the pixels adopting a bump pixel structure in the embodiment of the present disclosure. A flicker value of the flat pixel structure corresponding to the technical solutions in the related art is 16.5%, while the flicker value of the bump pixel structure in the embodiment of the present disclosure is 10.2%. It can be known that the brightness changing amplitude of the pixels adopting the bump pixel structure in the embodiment of the present disclosure is obviously smaller than that of the pixels adopting the flat pixel structure in the related art. Therefore, the flicker phenomenon of the horizontal electric field type TFT-LCD display device in the FFS display mode can be effectively improved.

It should be noted that in the embodiments of the present disclosure, the pixel electrodes and the common electrode are provided with protrusions to change the electric field direction, and particularly to change the electric field directions at the positions corresponding to the pixel electrodes and at the positions corresponding to the positions between every two pixel electrodes in the liquid crystal layer. Thus, the liquid crystal molecules at P1 and P2 positions are more likely to change to the tilting state from the vertical state, so as to improve the flicker problem caused by different speeds of the brightness change at P1 positions and P2 position. However, it may be appreciated that the pixel electrodes and the common electrode may also be provided with the recesses to change the electric field directions. For this point, the recess and the protrusion is equivalent, i.e. they can achieve the same effect individually. Any protrusion shown in the drawings may be replaced with a recess, and vice versa.

FIG. 17 shows a sectional schematic diagram of a display device having recess pixel electrodes and a recess common electrode in accordance with an embodiment of the present disclosure. In the embodiment shown in FIG. 17, each pixel electrode 4 has a recess, and the common electrode 6 has recesses at the positions corresponding to the positions between two adjacent pixel electrodes 4. Other embodiments may also be applicable. For example, the common electrode 6 has recesses at the positions corresponding to the positions between two adjacent pixel electrodes 4 and at the positions corresponding to each pixel electrode. For another example, the common electrode is provided with the recesses only at the positions corresponding to the positions between two adjacent pixel electrodes. Or only the pixel electrodes are provided with the recesses.

The embodiments of the present disclosure further provide a pixel structure. The pixel structure may be applied to the display device described in the present disclosure. The pixel structure comprises a first insulating layer, a common electrode layer formed by a common electrode, a second insulating layer and a pixel electrode layer formed by a plurality of pixel electrodes. The common electrode layer is disposed on the first insulating layer, the second insulating layer is disposed on the common electrode, and the plurality of pixel electrodes are disposed on the second insulating layer at intervals. At least one of the common electrode layer and the pixel electrode layer has a protrusion.

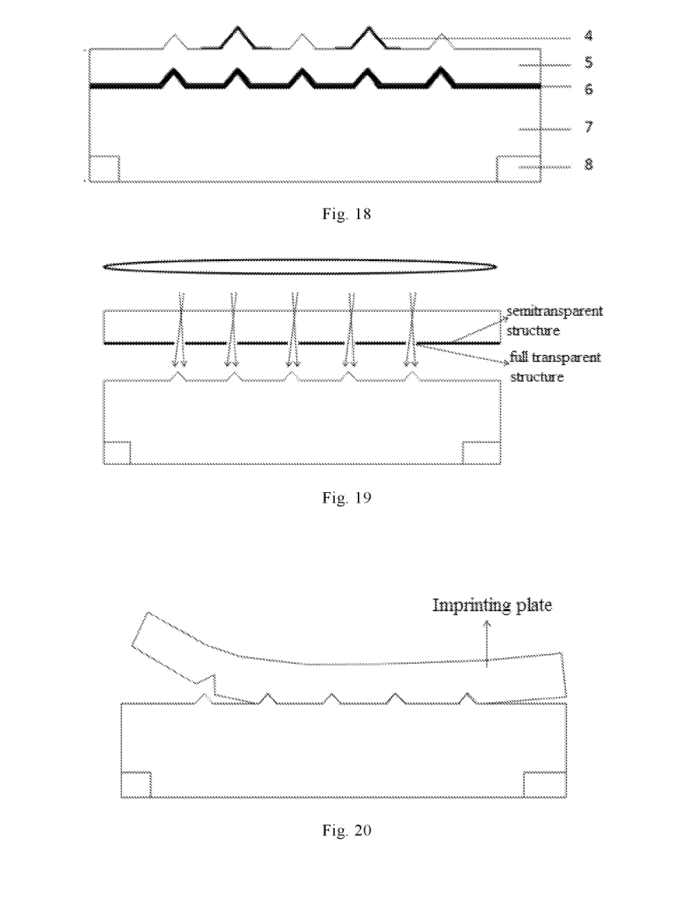

FIG. 18 shows a sectional schematic diagram of an exemplary pixel structure in accordance with an embodiment of the present disclosure. As shown in FIG. 18, the surface of the first insulating layer 7 facing the common electrode 6 may be provided with a plurality of protrusions. The positions of the plurality of protrusions correspond to the positions of the pixel electrodes 4 and to the positions between two adjacent pixel electrodes 4. The common electrode layer conformally covers the surface of the first insulating layer 7 having the plurality of protrusions, to cause the common electrode 6 to have a protrusion at the position corresponding to the pixel electrode 4 and at the position corresponding to the position between two adjacent pixel electrodes 4. The second insulating layer 5 conformally covers the common electrode 6, to cause the second insulating layer 5 to have a protrusion at the position corresponding to the position of the protrusion on the common electrode 6. The pixel electrodes 4 conformally cover the second insulating layer 5. Besides, the pixel electrodes and the protrusions are disposed alternately on the second insulating layer. Other embodiments may also be applicable.

Through this configuration, the pixel electrodes and the common electrodes are changed into nonplanar structures. When this pixel structure is applied to the display device, and particularly to a display panel, vertical field components of the electric fields between the pixel electrodes and the common electrode may be reduced, and the horizontal field components may be increased. Therefore, the rotary orientation of the liquid crystal molecules nearby the pixel electrodes is clearer during the switching between the positive and negative frames and the liquid crystal molecules are more likely to change to the tilting state from the vertical state or the near-vertical state. The speed of the liquid crystal molecules changing from the vertical state to the tilting state and the speed of changing from the tilting state to the vertical state tend to be the same. Thus, the brightness decay caused by the changing speed difference does not occur easily, thereby improving the flicker phenomenon of the display device.

The embodiments of the present disclosure further provide an array substrate. The array substrate may comprise the pixel structure described in the present disclosure. The array substrate may be applied to the display device described in the present disclosure, to improve the flicker phenomenon of the display device.

The embodiments of the present disclosure further provide a display panel adopting the above display device. The display panel may be applied to devices having a display function, such as liquid crystal televisions, liquid crystal displays, mobile phones, PDAs, tablet computers, etc.

Now a method for preparing an array substrate of the display device provided in the embodiments of the present disclosure is further introduced.

The method for preparing the array substrate in the present disclosure comprises the following steps:
forming a first insulating layer on a substrate; forming a common electrode layer comprising a common electrode on the first insulating layer; forming a second insulating layer on the common electrode layer; and forming a plurality of pixel electrodes on the second insulating layer at intervals to form a pixel electrode layer, wherein at least one of the common electrode layer and the pixel electrode layer has a protrusion, or a recess, or a combination thereof.

In an exemplary embodiment, at least one of the first insulating layer and the second insulating layer is formed to have a protrusion, or a recess, or a combination thereof, and the common electrode layer and the pixel electrode layer are conformally formed on the first insulating layer and the second insulating layer respectively, to cause at least one of the common electrode layer and the pixel electrode layer to have a protrusion, or a recess, or a combination thereof.

In an exemplary embodiment of the present disclosure, a plurality of protrusions or recesses may be formed on the surface of the first insulating layer during the process of preparing the first insulating layer. Then, the common electrode layer, the second insulating layer, the pixel electrode layer are conformally formed on the first insulating layer in sequence, to cause the each pixel electrode to have a protrusion and to cause the common electrode to have a protrusion or a recess at the position corresponding to the pixel electrode and at the position corresponding to the position between two adjacent pixel electrodes.

The common electrode and the pixel electrodes of the array substrate formed by the method of the embodiments of the present disclosure are both nonplanar structures. Thus, the vertical field components of the electric fields between the pixel electrodes and the common electrode may be reduced, and the horizontal field components may be increased, thereby improving the flicker phenomenon of the display device.

FIG. 19 shows a schematic diagram of a method for manufacturing a first insulating layer of an array substrate of a display device in the present disclosure. With this method, a protrusion, or a recess, or a combination thereof is formed on the first insulating layer by a halftone-mask patterning process. By taking the protrusion as an example, a protrusion is formed on the first insulating layer by exposure with a mask with a semitransparent structure. When the upper surface of the first insulating layer is prepared, a mask on the upper part of the first insulating layer is divided into full transparent structures and semitransparent structures. The semitransparent structures correspond to protrusion positions of the first insulating layer. The full transparent structures correspond to positions of the first insulating layer excluding the protrusion positions. By controlling the transmittance of the semitransparent structures, a protrusion corresponding to the full transparent structures is formed when the mask exposure is performed to upper surface of the first insulating layer.

FIG. 20 shows a schematic diagram of another method for forming a first insulating layer of an array substrate of a display device in the present disclosure. With this method, a protrusion, or a recess, or a combination thereof is formed on the first insulating layer by an imprinting process. By taking the protrusion as an example, an imprinting plate is used on the upper surface of the first insulating layer. This imprinting plate has a groove corresponding to the protrusion, so as to form the protrusion in the imprinting process.

An organic film structure of the first insulating layer having protrusion(s) in the present disclosure may also be obtained by a printing method such as a nano-printing method.

The pixel structure, the array substrate having the pixel structure, the display device having the array substrate, the display panel having the display device and the method for manufacturing the display device are described above. It is to be understood that those skilled in the art may make various modifications and substitutions to the details of the technical solutions based upon the contents and overall guidance of the present disclosure. Therefore, the specific embodiments described in the present specification are explanatory only and are not intended to limit the present disclosure. The protection scope of the present disclosure are indicated by the appended claims and by any and all equivalent technical solutions thereof.

1. A pixel structure, comprising a first insulating layer, a first electrode layer formed by a first electrode, a second insulating layer and a second electrode layer formed by a plurality of second electrodes, wherein
the first electrode layer is disposed on the first insulating layer;
the second insulating layer is disposed on the first electrode layer;
the plurality of second electrodes are disposed on the second insulating layer at intervals; and
at least one of the first electrode layer and the second electrode layer has a protrusion, or a recess, or a combination thereof.

2. The pixel structure according to claim 1, wherein each second electrode has a protrusion or a recess.

3. The pixel structure according to claim 1, wherein the first electrode has a protrusion or a recess at a position corresponding to the position between two adjacent second electrodes.

4. The pixel structure according to claim 3, wherein the first electrode has a protrusion or a recess at a position corresponding to the second electrode.

5. The pixel structure according to claim 2, wherein a surface of the second insulating layer is provided with a protrusion or a recess, or a combination thereof, and the second electrode conformally covers the second insulating layer, to cause the second electrode to have a protrusion or a recess.

6. The pixel structure according to claim 1, wherein the surface of the first insulating layer is provided with a protrusion or a recess at a position corresponding to the position between two adjacent second electrodes, and the first electrode conformally covers the first insulating layer, to cause the first electrode to have a protrusion or a recess at the position corresponding to the position between two adjacent second electrodes.

7. The pixel structure according to claim 6, wherein the surface of the first insulating layer is further provided with a protrusion or a recess at the position corresponding to the second electrode, to cause the first electrode to further have a protrusion or a recess at the position corresponding to the second electrode.

8. The pixel structure according to claim 7, wherein the second insulating layer conformally covers the first electrode, to cause the second insulating layer to have a protrusion or a recess at the position corresponding to the second electrode and at the position corresponding to the position between two adjacent second electrodes; and the second electrode conformally covers the second insulating layer, to cause the second electrode to have a protrusion or a recess.

9. The pixel structure according to claim 1, wherein the protrusion or the recess has the same shape.

10. The pixel structure according to claim 1, wherein the shape of the protrusion or the recess is selected from a triangle, a trapezoid, a convex polygon, an arc, or a combination thereof.

11. The pixel structure according to claim 10, wherein the protrusion or the recess is shaped like an isosceles triangle and a base angle of the isosceles triangle is 30°.

12. The pixel structure according to claim 1, wherein the first insulating layer comprises an organic material; and the second insulating layer comprises silicon nitride or silicon oxide.

13. An array substrate, comprising a pixel structure,
the pixel structure, comprising a first insulating layer, a first electrode layer formed by a first electrode, a second insulating layer and a second electrode layer formed by a plurality of second electrodes, wherein
the first electrode layer is disposed on the first insulating layer;
the second insulating layer is disposed on the first electrode layer;
the plurality of second electrodes are disposed on the second insulating layer at intervals; and
at least one of the first electrode layer and the second electrode layer has a protrusion, or a recess, or a combination thereof.

14. A display device, comprising a color filter substrate, an array substrate arranged opposite to the color filter substrate and a liquid crystal molecular layer filled between the color filter substrate and the array substrate, wherein the array substrate is provided with the pixel structure according to claim 1.

15. A display panel, comprising the display device of claim 14.

16. A method for manufacturing an array substrate of a display device, comprising the following steps:
forming a first insulating layer on a substrate;
forming a first electrode layer comprising a first electrode on the first insulating layer;
forming a second insulating layer on the first electrode layer; and
forming a plurality of second electrodes on the second insulating layer at intervals to form a second electrode layer,
wherein at least one of the first electrode layer and the second electrode layer has a protrusion, or a recess, or a combination thereof.

17. The method according to claim 16, wherein at least one of the first insulating layer and the second insulating layer is formed to have a protrusion, or a recess, or a combination thereof, and the first electrode layer and the second electrode layer are conformally formed on the first insulating layer and the second insulating layer, respectively, to cause at least one of the first electrode layer and the second electrode layer to have a protrusion, or a recess, or a combination thereof.

18. The method according to claim 16, wherein the first insulating layer is formed to have a protrusion, or a recess, or a combination thereof, and the first electrode layer, the second insulating layer and the second electrode layer are conformally formed on the first insulating layer in sequence, to cause the first electrode layer to have a protrusion or a recess at the position corresponding to the second electrode and at the position corresponding to the position between two adjacent second electrodes, and each second electrode has a protrusion or a recess.

19. (canceled)

20. The method according to claim 17, comprising forming a protrusion, or a recess, or a combination thereof on the first insulating layer by an imprinting process or a printing process.

21. The method according to claim 17, comprising forming a protrusion, or a recess, or a combination thereof on the first insulating layer by a halftone mask patterning process.
